(19) United States
(12) Patent Application Publication
(10) Pub. No.: US 2011/0011390 A1
(43) Pub. Date: Jan. 20, 2011

(54) CONTINUOUS LAMINATION OF POLYMETHYLEMETHACRYLATE (PMMA) FILM IN THE MANUFACTURE OF A FRESNEL LENS

(75) Inventors: Grant Bernard Lafontaine, Kennebunk, ME (US); Michael Thomas Pasierb, Sanford, ME (US)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Roehm GmbH, Darmstadt (DE)

(21) Appl. No.: 12/867,946

(22) PCT Filed: Mar. 16, 2009
(86) PCT No.: PCT/EP2009/053029

§ 371 Date: Aug. 17, 2010

Related U.S. Application Data
(60) Provisional application No. 61/041,948, filed on Apr. 3, 2008.

(51) Int. Cl. F24J 2/08; B32B 37/00; B32B 37/20; B29D 11/00; G02B 3/08

(52) U.S. Cl. 126/698; 156/60; 156/244.27; 156/250; 156/498; 359/742

(57) ABSTRACT

A method for forming a laminated product includes providing a film (2) having a first surface embossed with optical structures and an opposite second surface; guiding the film to a nip point of a pair of lamination rolls (5, 6); feeding a polymer sheet (4) to the nip point (7), wherein the polymer sheet has a surface temperature effective to enable thermal bonding between the polymer sheet and the film; and laminating the polymer sheet to the second surface of the film. The present process reduces the cost and environmental impact associated with laminating fresnel lens film to acrylic sheet versus existing industry technology.

### 1. FIELD

The invention relates generally to a method and process for laminating a film with embossed optical structures to a polymer sheet, more particularly, to a method and process that thermally bonds a film having a Fresnel lens pattern to a sheet without damaging the integrity of the lens structure.

### 2. DESCRIPTION OF THE RELATED ART

Fresnel lenses have been around since the 1800's and have been used in projection TVs, overhead projectors, automobile headlamps, lighthouses and the like. Recently, Fresnel lenses have been used to focus solar energy on photovoltaic solar receivers that convert the energy into electricity.

To improve the properties of a film embossed with optical elements, such as rigidity, weather resistance and abrasion resistance, it is desirable to laminate the embossed film to a support film. Normally a thin support film is sufficient for most of the purposes. However, when a Fresnel lens is used in a solar concentrator, it is desirable to laminate the Fresnel film to a thick sheet substrate in order to increase the rigidity of the Fresnel lens, and so that it can be easily installed in the solar concentrator.

The current industry standard process for making laminated Fresnel lenses involves an off-line method of cementing a commercially available Fresnel film to an acrylic sheet using methylene chloride. This process has a negative environmental impact because methylene chloride is a Hazardous Air Pollutant as listed by federal regulations. In addition, since the lamination is a separate step from the film extrusion or sheet extrusion process, it introduces more cost to the final product.

Thermal lamination allows an embossed film to bond to a support film under certain temperatures without the need for any adhesives. Off-line thermal lamination can be performed with thin films, but is problematic for thick films like Fresnel films. This is because thermally bonding a Fresnel film to a thick sheet requires a large amount of heat and this heat normally destroys the optical structures.

Embossed films have also been laminated onto carrier films through on-line lamination processes. U.S. Pat. No. 5,945,042, which is incorporated herein by reference in its entirety, describes a method of laminating a film with optical elements to a carrier film during the embossed film extrusion process. According to this method, a synthetic resin sheeting having a temperature equal to or higher than its flow starting temperature is first brought into close contact with a moving mold, then a carrier film is fed to the side of the sheeting opposite to the mold, and laminated thereto. The resulting laminated film is then cooled to a temperature lower than the glass transition temperature of the synthetic resin and is stripped from the mold.

U.S. Pat. No. 6,375,776, which is incorporated herein by reference in its entirety, discloses a process for laminating a carrier film to a thermoplastic polymeric film that has a precision pattern of embossed elements. According to the patent, a laminate is formed by continuously feeding onto a heated embossing tool a resinous film and a carrier film, wherein the resinous film is pressed against the embossing tool and is heated above its glass transition temperature, while the carrier film remains at a temperature below its glass transition temperature. After the resinous film bonds to the carrier film, the laminate is cooled and stripped from the embossing tool.

The on-line lamination methods disclosed in U.S. Pat. No. 5,945,042 and U.S. Pat. No. 6,375,776 work well with thin embossed films and thin carrier films. Patent '042 specifically discloses that the embossed films have a thickness in the range of 10 to 100 μm and the thickness of the carrier films is generally in the range of 35 to 150 μm.

On-line production of thick embossed sheets, such as Fresnel lenses with acrylic substrates have been disclosed in Benz, U.S. Pat. No. 5,656,209. Benz '209 describes a process for the manufacture of linear Fresnel lenses using a three roll polishing stack designed for coextrusion of a high viscosity molding compound and a low viscosity molding compound. This patent is incorporated herein by its entirety. While Benz '209 provides an on-line process to manufacture Fresnel lenses, the lenses produced by this process have been found to be less sharp at the edges.

There remains a need for a method effective to laminate Fresnel lenses to thick polymer sheets while at the same time brings minimal contamination to the environment.

### BRIEF SUMMARY

Disclosed herein is a thermal lamination process that reduces the cost and environmental impact associated with laminating a film embossed with optical structures to a polymer sheet versus existing industry technology.

The process includes the steps of: providing a film having a first surface embossed with optical structures and an opposite second surface; guiding the film to a nip point of a pair of lamination rolls; feeding a polymer sheet to the nip point, the polymer sheet having a surface temperature effective to enable thermal bonding between the polymer sheet and the film; and laminating the polymer sheet to the second surface of the film.

In one embodiment, the embossed structure is a Fresnel lens, and the polymer sheet is an acrylic sheet, preferably a PMMA sheet.

The present process requires no adhesives or additional heat. There are minimal sources for additional contamination other than the film itself. The additional equipment required is relatively simple and inexpensive to fabricate.

### BRIEF DESCRIPTION OF THE DRAWINGS

FIG. 1 is a schematic diagram showing the process and the apparatus involved in the lamination of an embossed film with a polymer sheet.

FIG. 2 is a schematic enlarged sectional view of a part of the apparatus of FIG. 1.

FIG. 3 is a front view of a laminated Fresnel film according to one embodiment of the present invention.

### DETAILED DESCRIPTION

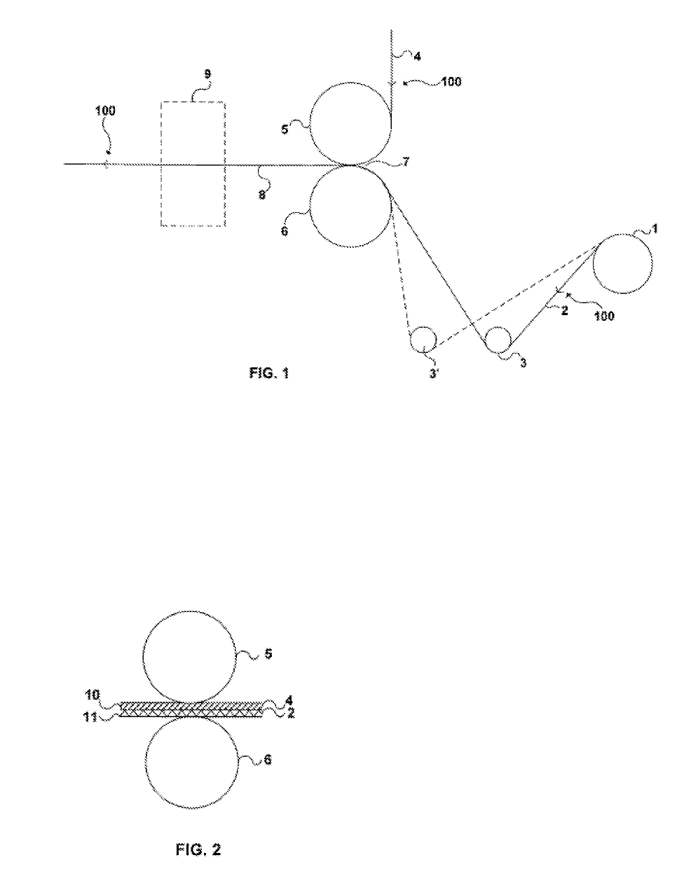

Referring to the drawings, and initially to FIG. 1, a schematic diagram is shown illustrating the process and the apparatus involved in laminating an embossed film onto a polymer sheet. As shown in the diagram with arrow heading 100 showing direction of work flow, a polymer sheet 4 and a film 2 are fed into a nip point 7 of two calendar rolls 5 and 6 and are bonded to each other. Both of the calendar rolls are cold hard metal rolls.

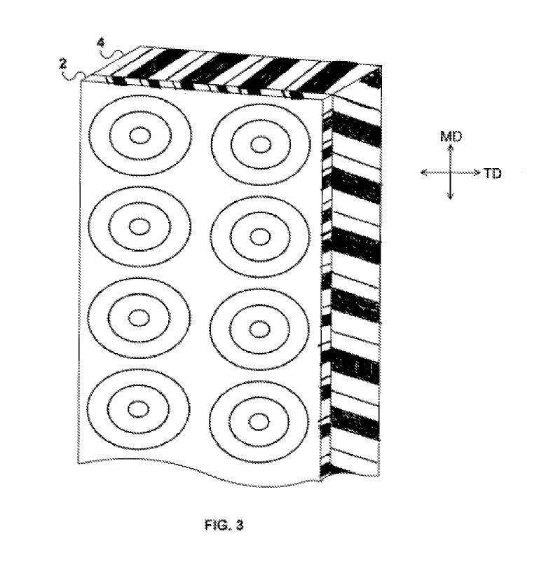

As shown in FIG. 2, film 2 has a first surface 11 that is embossed with optical structures and a second surface 10 that is to be laminated to polymer sheet 4. Film 2 may be embossed with any known process and is at ambient temperature before lamination. Film 2 may also be obtained from commercial sources. Referring back to FIG. 1, in one embodiment, film 2 is supplied in roll 1 and is fed into nip point 7 through one or more guiding rolls 3. It is appreciated that film 2 can be fed into nip point 7 from different angles as shown in FIG. 1 such as by offsetting Guiding Roll 3′.

In the present application, a polymer sheet is defined as a sheet having a thickness of greater than 1 mm. In one embodiment of the invention, polymer sheet 4 is prepared from a conventional sheet extrusion process. And when the sheet is still hot and pliable, it is fed into nip point 7 to come into close contact with surface 10 (FIG. 2) of film 2. The temperature of polymer sheet 4 at nip point 7 is crucial to the success of the lamination. If the surface temperature is too low, there will be no bonding. If the surface temperature is too high, the optical structures of film 2 will be destroyed. It is appreciated that polymer sheet 4 has a surface temperature that is effective to ensure a thermal bonding between sheet 4 and film 2 while at the same time keep the integrity of the optical structures of film 2. For a 3 mm PMMA polymer sheet, an exemplary surface temperature at the point of operation is in the range of from about 120° C. to about 175° C. and preferably 140° C. to 160° C.

After film 2 is brought in close contact with polymer sheet 4 at nip point 7, a thermal bonding occurs and film 2 is laminated to sheet 4. There is no external heat needed during the lamination. The heat required for thermal bonding is provided by the internal heat from sheet 4. During the lamination process, the surface temperature of film 2 is maintained below its glass transition temperature to prevent the distortion of the optical structures.

After lamination, the laminate is then guided to cooling zone 9, which includes a plurality of cooling rolls. After the laminate is cooled to room temperature, nominally, 22° C., the finished product is cut, such as by a flying saw at the end point.

In one embodiment, the optical structure is a Fresnel lens and the polymer sheet is an acrylic sheet, preferably a PMMA (polymethylmethacrylate) sheet. The Fresnel lense could be square, rectangular or other desired shape. Although no particular limitation is placed on the thickness of the film, it may generally be in the range of 0.5 to 0.9 mm. The thickness of the polymer sheet may generally be in the range of 1.85 to 5.85 mm.

In another embodiment of the invention, the film consists of roughly 7″×7″ square individual lenses arranged in a grid pattern. FIG. 3 provides a front view of a laminated Fresnel film according to this embodiment.

At normal operating conditions for ordinary sheet products, the film stretches in the machine direction (MD) and shrinks in the transverse direction (TD), as seen from lens width and length measurements before and after lamination. Conventionally, a certain amount of tension is applied in the MD in order to prevent the ribbon from sagging immediate after the calendaring process. It is discovered now that the stretch can be eliminated by reducing the MD tension. Detailed shrink/stretch data under various operating conditions is shown in Table 1.

Warpage is another problem that a laminated product may experience. Normally, after lamination, the sheet warps concave towards the Fresnel surface. One way to measure warpage is by cutting two 36.5″ long×4″ wide strips in each direction, placing them vertically with concave surfaces facing each other, measuring the widest distance between them, and halving the result. Typical warpage on a 3 mm laminated substrate is nominally 13 mm in each direction. The inventors discovered that there are several ways to reduce the warpage effect.

Firstly, when an impact modifier is added to a sheet substrate, the resulting warpage is reduced significantly. For example, when 8% butyl acrylate is added to a sheet substrate, the nominal resulting warpage is reduced from 13 mm to 7 mm.

Normally the film's base polymer resin has a butyl-acrylate impact modifier added, which reduces its brittleness and facilitates winding onto rolls. However, the typical base polymer of the polymer sheet has no impact modifier, and therefore has a different coefficient of thermal expansion from the film. As the sheet cools, the substrate and film shrink to different final sizes, causing the warpage. The introduction of an impact modifier to the base sheet substrate reduces the thermal expansion coefficient differential between the film and the sheet, and therefore reduces warpage significantly.

Secondly, air-cooling the Fresnel lens film surface downstream of the nip point reduces warpage to a varying degree. For example, air-cooling the laminate at different downstream locations reduces the nominal warpage from 13 mm to 7-12.5 mm. Detailed experimental data about the warpage effect under different operation conditions is shown in Table 2.

TABLE 1

| Application | | | First 3 | | Blower at | Blower at | | | |
|---|---|---|---|---|---|---|---|---|---|
| Roll | | Pull Roll | Cooling Rolls' | Blower at 1^{st} | 3^{rd} Cooling | 5^{th} Cooling | Heat Gun | % TD | % MD |
| Temp (° C.) | | Ratio | Ratio | Cooling Roll | Roll | Roll | Applied to Film | Shrink | Stretch |
| Control | 97 | 0.996 | 0.985-0.990- | | | | | 2.8% | 1.0% |
| | | | 0.995 | | | | | | |
| | 97 | 0.996 | 0.985-0.990- | | | | X | 2.9% | 1.1% |
| | | | 0.995 | | | | | | |
| | 97 | 0.976 | 0.955-0.960- | | | | | 2.1% | −0.6% |
| | | | 0.985 | | | | | | |
| | 97 | 0.986 | 0.970-0.970- | X | X | | | 2.2% | 0.2% |
| | | | 0.970 | | | | | | |
| | 97 | 0.986 | 0.970-0.970- | | X | | | 2.4% | 0.1% |
| | | | 0.970 | | | | | | |
| | 97 | 0.986 | 0.970-0.970- | | X | X | | 2.4% | −0.3% |
| | | | 0.970 | | | | | | |
| | 97 | 0.986 | 0.970-0.970- | | | X | | 2.5% | 0.2% |
| | | | 0.970 | | | | | | |
| | 87 | 0.986 | 0.970-0.970- | | | X | | 2.4% | 0.1% |
| | | | 0.970 | | | | | | |

TABLE 2

| | | | | | | Film Surface | Blower at | Blower at | | |
|---|---|---|---|---|---|---|---|---|---|---|
| Extruder | | Base | Surface | Application | Pull Roll | Applied to | Cooling | Cooling | TD Warp | MD Warp |
| RPM | | Polymer | Polymer | Roll | Ratio | Sheet | Roll +#5 | Roll #7 | (mm) | (mm) |
| Control | 57 | Standard | Standard | Calendar | 1.005 | Smooth | | | 13.5 | 12.5 |
| | | PMMA | PMMA | Roll | | | | | | |
| | 65 | Standard | High Flow | 5^{th} Cooling | 1.005 | Smooth | | | 16.0 | 10.0 |
| | | PMMA | PMMA | Roll | | | | | | |
| | 65 | Standard | High Flow | Calendar | 1.005 | Smooth | | | 11.0 | 11.0 |
| | | PMMA | PMMA | Roll | | | | | | |
| | 65 | Standard | Standard | Calendar | 0.985 | Smooth | | | 13.0 | 9.0 |
| | | PMMA | PMMA | Roll | | | | | | |
| | 65 | Standard | Standard | Calendar | 0.985 | Smooth | X | | 7.0 | 12.5 |
| | | PMMA | PMMA | Roll | | | | | | |
| | 65 | Standard | Standard | Calendar | 0.985 | Smooth | | X | 9.0 | 10.0 |
| | | PMMA | PMMA | Roll | | | | | | |
| | 65 | Standard | Standard | Calendar | 1.005 | Textured | | | 8.5 | 8.5 |
| | | PMMA | PMMA | Roll | | | | | | |
| | 57 | 50% Impact | 50% Impact | Calendar | 0.985 | Smooth | | | 7.0 | 6.5 |
| | | Modifier | Modifier | Roll | | | | | | |

Examples of the laminated Fresnel films formed by the present invention are presented herewith as Examples 1-5.

### Example 1

A modified acrylic film with an embossed pattern of multiple, circular Fresnel lenses was laminated to a semi-molten acrylic polymer sheet. The film was a product of the 3M Company of Minneapolis Minn. The embossed film was supplied on a roll and was fed from the roll into a nip point of a pair of calendar rolls. The polymer sheet was formed using conventional sheet extrusion process. The acrylic sheet to which the film was being laminated was 3 mm thick and had a surface temperature of 148° C. to 150° C. at the point of lamination. The gap between the pair of calendar rolls was adjusted to provide enough pressure to assure that the applied film had complete contact with the acrylic polymer at the point of operation. It is important to keep the temperature of the embossed surface below its glass transition temperature to maintain the sharpness of the embossed pattern. The ratio of the speed of the last roll and the haul-off rolls was maintained to a ratio of 0.980 to 1.00 to keep the embossed Fresnel lenses from becoming distorted as the sheet and film laminate cool to room temperature.

### Example 2

The process was the same as disclosed in Example 1, except that a continuous linear Fresnel pattern was embossed into the film being applied to the sheet being formed.

### Example 3

The base extruded polymer sheet was formed by co-extrusion of an acrylic based polymer, with a lower softening temperature than the core polymer, on one or both sides of the sheet. This allowed the surface of the sheet to be softer and when pressure was applied to the laminating film, the softer polymer was able to flow to the areas of lower pressure and fill gaps between the film and the substrate sheet providing better adhesion. The remaining set up was the same as Example 1.

### Example 4

The laminate was formed as in Example 1, 2 and 3 but with the final calendar roll having a rubber covering of sufficient compressibility and temperature capacity to apply more even pressure to the film/polymer sheet nip point to compensate for film thickness variations.

### Example 5

The laminate was formed as in Examples 1-4. Detailed experimental design and the lamination results were shown in Table 3.

TABLE 3

| | | | | Nominal | Roll | Actual Break | | | |
|---|---|---|---|---|---|---|---|---|---|
| | | Roll 6 | Roll Gap | Brake | Diameter | Pressure | % TD | % | % MD |
| Trial # | Run # | Temp | (mm) | Pressure (psi) | (inches) | (psi) | Shrink | Adhered | Stretch |
| 4 | 1 | 55 | 0.4 | 25 | 16.0 | 22 | 2.03 | 65 | −0.02 |
| 1 | 2 | 55 | 0.3 | 20 | 15.5 | 18 | 1.99 | 100 | −0.15 |
| 6 | 3 | 55 | 0.4 | 20 | 15.0 | 17 | 1.91 | 69 | −0.30 |
| 8 | 4 | 55 | 0.4 | 25 | 14.5 | 21 | 1.93 | 85 | −0.13 |
| 7 | 5 | 55 | 0.3 | 25 | 14.5 | 21 | 1.98 | 85 | −0.09 |
| 2 | 6 | 55 | 0.4 | 20 | 13.5 | 16 | 1.98 | 68 | −0.08 |
| 3 | 7 | 55 | 0.3 | 25 | 13.5 | 19 | 2.01 | 100 | −0.06 |
| 5 | 8 | 55 | 0.3 | 20 | 12.5 | 15 | 2.01 | 100 | −0.10 |
| 10 | 9 | 90 | 0.4 | 20 | 12.5 | 14 | 2.11 | 100 | 0.13 |
| 16 | 10 | 90 | 0.4 | 25 | 11.0 | 17 | 2.14 | 100 | 0.13 |
| 15 | 11 | 90 | 0.3 | 25 | 10.5 | 15 | 2.19 | 100 | 0.11 |
| 14 | 12 | 90 | 0.4 | 20 | 9.5 | 12 | 2.13 | 100 | 0.21 |
| 12 | 13 | 90 | 0.4 | 25 | 9.0 | 14 | 2.11 | 100 | 0.19 |
| 9 | 14 | 90 | 0.3 | 20 | 8.5 | 10 | 2.14 | 100 | 0.08 |
| 13 | 15 | 90 | 0.3 | 20 | 7.5 | 9 | 2.21 | 100 | −0.02 |
| 11 | 16 | 90 | 0.3 | 25 | 17.5 | 25 | 2.29 | 100 | 0.24 |

“Break Pressure” was adjusted for decreasing film roll diameter. 20 psi and 25 psi are nominal for full roll diameter (17.5′)
% TD Shrink indicated transverse direction lens shrinkage-large number means smaller lens after lamination
% MD Stretch indicated machine direction lens stretch-large number means larger lens after lamination

1. A method for forming a laminated product comprising the steps of:
providing a film having a first surface embossed with optical structures and an opposite second surface;
guiding said film to a nip point of a pair of lamination rolls;
feeding a polymer sheet to said nip point, said polymer sheet having a surface temperature effective to enable thermal bonding between said polymer sheet and said film; and
laminating said polymer sheet to said second surface of said film.

2. The method of claim 1, wherein said film is an acrylic-based film.

3. The method of claim 1, wherein said film has a thickness in the range of about 0.5 mm to about 0.9 mm.

4. The method of claim 1, wherein the temperature of said first surface of said film is below the glass transition temperature of said film.

5. The method of claim 1, wherein said optical structure is a Fresnel lens.

6. The method of claim 1, wherein said film comprises a matrix of square individual Fresnel lenses arranged in a grid pattern.

7. The method of claim 1, wherein the film is configured as a linear Fresnel lens where the pattern is continuous for the length of the film.

8. The method of claim 1, wherein said polymer sheet is a PMMA sheet.

9. The method of claim 8, wherein the base polymer of said polymer sheet comprises a butyl acrylate modifier.

10. The method of claim 1, wherein said polymer sheet has a thickness in the range of about 1.85 mm to about 5.85 mm.

11. The method of claim 1, wherein said polymer sheet is 3 mm thick and the surface temperature of said polymer sheet at said nip point is in the range of about 148° C. to about 150° C.

12. The method of claim 1, further comprising the step of forming the polymer sheet by an extrusion process immediately before said sheet is fed into said nip point.

13. The method of claim 12, wherein said polymer sheet is formed by co-extrusion of a polymer on one or both sides of said polymer sheet, said polymer having a lower softening temperature than the base polymer of said polymer sheet.

14. The method of claim 1, further comprising the step of adjusting calendar roll pressure manually to compensate for inconsistent thickness of said film.

15. The method of claim 1, further comprising the step of cooling the laminated product at one or more downstream locations of said lamination rolls.

16. The method of claim 1, further comprising the step of cutting the laminated product by a transverse flying saw.

17. The apparatus of laminating a film with optical structures to an extruded polymer sheet comprising:
a first cold lamination roll;
a second cold lamination roll, said first cold lamination roll and second cold lamination rolls forming a nip point in between;
a let off stand for the film, said let off stand being supplied with a breaking system for maintaining tension on the film; and
one or more guiding rollers that allows the film to be fed to said nip point from different angles.

18. The apparatus of claim 17, wherein the apparatus further comprising an air cooling system installed in a downstream location of said first and second lamination rolls.

19. The apparatus of claim 17, wherein said second lamination roll has a rubber covering.

20. A laminated Fresnel lens manufactured by a process comprising the steps of:
providing a film having a first surface embossed with optical structures and an opposite second surface;
guiding said film to a nip point of a pair of lamination rolls;
feeding a polymer sheet to said nip point, said polymer sheet having a surface temperature effective to enable thermal bonding between said polymer sheet and said film; and
laminating said polymer sheet to said second surface of said film.

21. A solar collector having a laminated Fresnel lens being manufactured by a process comprising the steps of:
providing a film having a first surface embossed with optical structures and an opposite second surface;
guiding said film to a nip point of a pair of lamination rolls;
feeding a polymer sheet to said nip point, said polymer sheet having a surface temperature effective to enable thermal bonding between said polymer sheet and said film; and
laminating said polymer sheet to said second surface of said film.
